(19) United States
(12) Patent Application Publication
(10) Pub. No.: US 2009/0208655 A1
(43) Pub. Date: Aug. 20, 2009

(54) Method for manufacturing a bituminous coated material consisting of adding the binder and a portion of the solid mineral fractions simultaneously to the mixer

(75) Inventors: Frederic Delfosse, Pessac (FR); Thierry De Sars, Lyon (FR)

Correspondence Address: FOLEY AND LARDNER LLP;SUITE 500, 3000 K STREET NW, WASHINGTON, DC, 20007, US

(73) Assignee: Eurovia

(21) Appl. No.: 12/320,708

(22) Filed: Feb. 2, 2009

(30) Foreign Application Priority Data
Feb. 1, 2008 (FR) 0850643

(51) Int. Cl. B05D 3/02

(52) U.S. Cl. 427/314

(57) ABSTRACT

The invention relates to a method for manufacturing a bituminous coated material comprising mineral solid fractions coated with a binder, wherein the method comprises a step of heating a portion of said mineral solid fractions and adding separately but simultaneously the binder and the remaining portion of said mineral solid fractions.

Application to road construction.

The invention relates to a method for manufacturing a bituminous coated material comprising mineral solid fractions coated with a binder, wherein the method comprises a step of heating a portion of said mineral solid fractions followed by a step of adding the binder and the remaining portion of said mineral solid fractions simultaneously.

The term “mineral solid fractions” as used herein means all solid fractions which can be used to produce bituminous coated materials in particular for road construction, including in particular natural mineral aggregates (aggregate, sand, fines), and reclaimed aggregates of coated materials resulting from the recycling of materials recuperated from road repairs as well as excess from mixing plants. As used herein, the term <<reclaimed aggregates of coated materials >> means coated materials (mixture of aggregates and bituminous binders) resulting from the milling of layers of coated material, the crushing of plates extracted from pavements made of coated materials, of pieces of plates of coated materials, of waste of coated material or of overproduction of coated materials (overproduction consists of coated or partially coated materials in a mixing plant resulting from intermediate manufacturing stages).

The mineral solid fractions can be selected from components smaller than 0.063 mm (filler or fines), sand including components smaller than 2 mm, aggregates including components having sizes above 2 mm and reclaimed aggregates resulting from recycled materials including components with sizes up to 31.5 mm (also called recycled asphalt product).

As used herein, the term “binder” means any hydrocarbon binder of fossil or plant origin usable for preparing coated materials, in particular pure asphalt or asphalt added with fluxes and/or with thinners and/or with reclaiming agents and/or with pigments and/or modified by addition of polymers. Such binder can also be doped by adding adhesiveness agents (derived from fatty amines, such as Polyram L 200 supplied by the company CECA, or alkylamido-imidazopolyamines).

This binder can be added as is or modified so as to be in the form of an emulsion, a dispersion or an asphalt foam. As used herein, the term asphalt foam means a method consisting in injecting into the binder inlet an amount of water and optionally air, with the water being pure or added with additives for modifying the adhesive or even rheological properties of the binder.

In the conventional hot coating method, the mineral solid fractions are dried, prior to the coating step, so as to remove the water content from the mineral solid fractions, which requires a considerable energy consumption because of the large amount of water initially contained in these fractions, in particular in the sand and the aggregates. Furthermore, the drying and temperature increase result in smoke emission containing steam loaded with dusts. In view of environmental concerns, it is essential to take a maximum of safety measures to reduce and/or to treat these gas effluents, which leads to carrying out the method in both a more complex and more expensive way.

To overcome this problem, EP 1 469 038 A suggests that the drying step should involve a first portion of the mineral solid fractions, substantially free of fines, to coat such first portion with hot asphalt, and then to add to the resulting mixture a second portion of mineral solid fractions, comprising sands and fines.

This method requires providing two mineral solid fractions, one of them being free of fines and the other one containing fines, which can cause problems. Furthermore, this method cannot be carried out efficiently in some existing coating plants, and may thus involve costly additional equipment.

FR 2 884 265 provides an equivalent method wherein the first portion of the mineral solid fractions can contain fines.

FR 2 884 264 provides a method wherein the total mineral solid fractions (aggregates, sands, and fines) is subjected to a method consisting in drying while leaving a fraction of the initial water content, followed by the coating of the material.

However, such methods cause an increase in the mixing time because of the sequence of stages and accordingly a decrease in the production rates of the batch-type plants, or the possible requirement of lengthening the mixers within continuous-type plants.

The object of the invention is to overcome all or part of these drawbacks.

The invention thus provides a method for manufacturing bituminous coated materials comprising solid mineral fractions coated with a binder, wherein the method comprises the sequential steps of:
a) adding to a mixer (a device in which the binder and the solid mineral fractions are mixed) a first portion of said solid mineral fractions, said first portion having been at least partially heated beforehand up to a temperature at the inlet of said mixer which is higher than 80° C., preferably higher than 100° C.; then
b) adding separately but simultaneously, to the same mixer, the binder and the remaining portion of said solid mineral fractions not heated beforehand.
   Preferably, said first portion of solid fractions is itself subdivided into two portions. In particular, step a) is subdivided into two sequential steps of:
a1) heating to a temperature higher than 120° C. the first subdivision of said first portion of said mineral solid fractions free of reclaimed aggregates of coated materials; then
a2) mixing said first heated subdivision obtained in step a1), while hot, with the second subdivision of said first portion of the mineral solid fractions which may include reclaimed aggregates of coated materials.

The phrase <<while hot >> means that said first heated subdivision is, at the beginning of step a2), at a temperature such that the mix resulting from mixing said first subdivision with said second subdivision is at a temperature higher than 80° C., preferably higher than 100° C.

Preferably, said second subdivision does not require prior heating.

The solid mineral fractions added in steps a) and b) preferably both comprise fines, sand and aggregate (such as defined above). They can further comprise reclaimed aggregates of coated materials (such as defined above).

Accordingly, the solid mineral fractions added in step b) preferably comprise sand including components smaller than 2 mm, aggregate including components having sizes above 2 mm and optionally reclaimed aggregates resulting from recycled materials including components with sizes up to 31.5 mm.

It should be recalled that the solid mineral fractions added in step b) are preferably used cold (i.e. at room temperature), in particular they have not been heated beforehand. The reclaimed aggregates resulting from recycled materials which can be added at this step b) are preferably used cold, i.e. they have not been heated beforehand.

As used herein, the term <<adding separately but simultaneously >> means that said remaining portion of the solid mineral fractions is not already mixed with the binder upon adding and that addition of the binder and of said remaining portion to the mixer begins substantially at the same time.

As used herein, the term <<not heated beforehand >> means that the solid mineral fraction is added cold (i.e. at room temperature) and that it has not been, at any time during the process, dried with heat.

During step b), the binder and said remaining portion of the solid fractions are added in separately but simultaneously into said first portion of the solid mineral fractions. The binder and said remaining portion of the solid fractions have not been mixed beforehand.

The end of the time period for adding the binder and said remaining portion of the solid fractions can be the same or different. According to one embodiment of the invention, during step b) the whole of said remaining portion of the solid mineral fractions is added simultaneously to the binder in such a way that the whole of said remaining portion of the solid mineral fractions is mixed-in while only a portion of the binder has been mixed-in (or the whole of the binder and then the ends of adding times are the same). According to another embodiment of the invention, during step b) the whole of the binder is added simultaneously with the addition of said remaining portion of said solid mineral fractions in such a way that the whole of the binder is mixed-in whereas only a portion of said remaining portion of the solid fractions has been mixed-in (or the whole of said fractions and then the ends of adding time are the same).

According to a preferred embodiment of the invention, the method makes it possible to upgrade reclaimed aggregates of coated materials resulting from the recycling of the materials recuperated from road repairs (and others).

The method according to the invention is thus characterized in that in step a) said first portion of solid mineral fractions comprises reclaimed aggregates of coated materials. In this case, said first portion of solid fractions is itself subdivided into two portions, one such subdivision comprising reclaimed aggregates of coated materials. Step a) is then preferably subdivided into two sequential steps of:
a1) heating to a temperature higher than 120° C., preferably higher than 130° C., the first subdivision of said first portion of the mineral solid fractions free of reclaimed aggregates of coated materials; then
a2) mixing said first subdivision obtained in step a1), maintained at the same temperature, with the second subdivision of said first portion of the mineral solid fractions including reclaimed aggregates of coated materials.

The inventors have found that even better results could be obtained when using reclaimed aggregates of coated materials; i.e. aggregates of coated materials having been contacted with a reclaiming agent. The aim is to regenerate the old binder, the hardening of which is a result of physicochemical conversion of some of its components, by adjusting its consistency and its chemical constitution by means of a suitable agent, qui should be a solvent of the binder. This reclaiming agent has a thinning and repeptising capacity (dispersion of the asphaltenes) over the old binder which is sufficient to reconstitute, with said old binder, a binder having the desired properties (mechanical and rheological properties). Employing such a reclaiming agent enables to enhance the migration of the old binder (present in the reclaimed aggregates of coated materials) towards the new mineral solid fractions, so that it also gets distributed over the whole of the mineral solid fractions.

The reclaiming agent can be of petroleum, coal, plant, or mineral origin, or a combination thereof. Included are in particular vegetable oils, mineral oils (paraffin), aromatic oils, and recycling binders of aromatic nature with low contents of asphaltenes. These last two classes in particular are commercially available from TOTAL under the Regenis® range of products. The amount of reclaiming agent will be in the range of between 1 and 50% based on the binder content of the reclaimed aggregate of coated materials and preferably between 10 and 30%.

In a preferred alternative of the invention, the reclaimed aggregates of coated materials represent between 5% and 70% and preferably from 20 to 40% in mass of the weight of mineral solid fractions comprising said first portion.

The grade of the filler asphalt and its amount will be determined according to the percentage of reclaiming agent, of asphalt present in the reclaimed aggregates of coated materials and of the specifications expected for the coated material.

In the method according to the invention, the remaining portion added in step b) represents preferably from 5 to 501, more preferably 10 to 50%, even more preferably 20 to 40% in mass, based on the weight of said solid mineral fractions.

According to a preferred embodiment of the invention, a controlled amount of water is added. This water can be added during step b) of adding the binder and said remaining portion simultaneously. It can also be added after step b). It can further be added to said remaining portion of solid mineral fractions prior to step b). The water can be added to one of these steps or to several of them. By using solid mineral fractions not heated beforehand (and thus humid as they have not been dried) and by optionally adding water, it is possible to control the water content in the mixer during this step b).

The binder is preferably processed at a temperature in the range of between 100 and 200° C., preferably of about 160° C. The binder emulsion is preferably processed at a temperature in the range of between 10 and 95° C.

Thus, adding a non-dried solid mineral fraction (step b) at room temperature results in lowering the outlet temperature of the coated materials.

Compared to the prior art method, since the mixing of said remaining portion of mineral solid fractions and the binder is carried out during the same stage, this method enables to reduce the cycle times and thus to increase the production capacities of batch production plants and to decrease the mixer lengths of continuous-type plants, at a matching coating quality.

This method also enables to enhance the coating by substantial expansion of the binder and thus its surface area, upon contact with the water mixed-in directly or indirectly through addition of said remaining portion of the non-heated solid fractions whereas:
In FR Patent 2 884 265 and EP Patent 1 469 038 A, the binder/solid fraction interface is already built up prior to adding water either directly or indirectly through the addition of the humid solid fragments, and cannot thus be modified anymore.
In FR Patent 2 884 264, the direct or indirect addition of water is carried out:
   either in a stage prior to the addition of the binder, a major part of this water has evaporated and thus does not enable anymore sufficient expansion so as to reduce the cycle times and/or mixing times at a matching coating quality.
   Or in a stage subsequent to the coating, with the same drawbacks as for FR Patent 2 884 265 and EP Patent 1 469 038 A (see above).

In one embodiment, the method according to the invention is carried out in batch-type plants. In another embodiment, it is carried out in continuous plants, preferably those of the co-current drum dryer-mixer type, counter-current single shell drum dryer-mixer type, and drum dryer type with a separate mixer of the parallel-shaft type or of the drum mixer type.

The invention is illustrated below by way of examples. In these examples, the binder is an asphalt with a penetration index of 35/50 or 20/30 according to the NF EN 1426 standard. The percentages are given in mass based on the total mass of the bituminous coated materials.

Examples 1 to 3 have been carried out in a laboratory. Examples 4 to 6 have been carried out on a construction site.

### EXAMPLE 1

### BBSG 0/10 Diorite

The solid fragments consist of aggregates having a size of 0/10 mm, made of diorite having the following particle size distribution in the final coated material:

| | |
|---|---|
| 6/10 | 35% |
| 2/6 | 19% |
| 0/2 | 40.6% |

The binder is an asphalt having a penetration index of 35/50: 5.4%.

65% of the aggregates (11% 0/2, 19% 2/6 and 35% 6/10) are heated to 140° C. followed by mixing by means of a mixer. Then, the rest of the 0/2 fraction having a water content of 3% and the asphalt (heated to 160° C.) are simultaneously added to the mixer (containing the heated fraction).

The coated material is mixed and the final temperature is 98° C.

The characteristics of the resulting coated material are shown in Table 1 below:

TABLE 1

| | | | Specifications | | |
|---|---|---|---|---|---|
| | | | NF EN 13108-1 | | |
| | | Results | C I | C II | C III |
| DURIEZ test | average void % | 7 | | | |
| NFP 98-251-1 | R18 (MPa) | 12.4 | | | |
| | r18 (MPa) | 10 | | | |
| | r/R | 0.81 | >0.75 | | |
| Rutting | void % | 7.2 | 5-8 | | |
| NF EN 12697- | rut at 30000 | 4.5 | <10 | <7.5 | <5 |
| 22 | cycles % | | | | |
| GSP | void % 60 | 7.8 | 5-10 | | |
| NF EN 12697- | gyrations | | | | |
| 32 | | | | | |
| Module | Average direct | 11640 | >5500 | >7000 | >7000 |
| according to | tension | | | | |
| NF EN 12697- | modulus | | | | |
| 26 | (15° C.- 0.02 s | | | | |
| | in MPa) | | | | |

| | | | |
|---|---|---|---|
| | average void % | 6.8 | 5-8 |
| Fatigue | ε6 at 10° C. - | 104 | >100 |
| strength | 25 Hz (μdef) | | |
| according to | average void % | 7.5 | 5-8 |
| NF EN 12697- | fatigue | | |
| 24 | | | |

### EXAMPLE 2

### BBSG 0/10 Diorite+Reclaimed Aggregates of Coated Materials

The solid fragments consist of 24% reclaimed aggregates of coated materials and aggregates having a size of 0/10 mm, made of diorite having the following particle size distribution in the final coated material:

| | |
|---|---|
| 6/10 | 32.6% |
| 2/6 | 15.3% |
| 0/2 | 24% |

The binder is an asphalt of penetration index 35/50: 4.1% (i.e. total asphalt: 5.4%)

The reclaimed aggregates of coated materials and the 2/6 and 6/10 aggregates are heated to 140° C. Then, the 0/2 fraction having a water content of 4% and the asphalt (heated to 160° C.) are simultaneously added to the mixer (containing the heated fraction).

The coated material is mixed and the final temperature is 100° C.

The characteristics of the resulting coated material are shown in Table 2 below:

TABLE 2

| | | | Specifications | | |
|---|---|---|---|---|---|
| | | | NF EN 13108-1 | | |
| | | Results | C I | C II | C III |
| DURIEZ test | average void % | 8 | | | |
| NFP 98-251-1 | R18 (MPa) | 13.2 | | | |
| | r18 (MPa) | 10.5 | | | |
| | r/R | 0.80 | >0.75 | | |
| Rutting | void % | 7.9 | 5-8 | | |
| NF EN 12697- | rut at 30000 | 4.1 | <10 | <7.5 | <5 |
| 22 | cycles % | | | | |
| GSP | void % 60 | 8.7 | 5-10 | | |
| NF EN 12697- | gyrations | | | | |
| 32 | | | | | |
| Module | Average direct | 12930 | >5500 | >7000 | >7000 |
| according to | tension | | | | |
| NF EN 12697- | modulus | | | | |
| 26 | (15° C. - 0.02 s | | | | |
| | in MPa) | | | | |

| | | | |
|---|---|---|---|
| | average void % | 7.2 | 5-8 |
| Fatigue | ε6 at | 102 | >100 |
| strength | 10° C. - 25 Hz | | |
| according to | (μdef) average | 7.9 | 5-8 |
| NF EN 12697- | void % | | |
| 24 | fatigue | | |

### EXAMPLE 3

### BBSG 0/10 Diorite+Reclaimed Aggregates of Coated Materials, 20/30 Asphalt+Reclaiming Agent

The solid fragments consist of aggregates having a size of 0/10 mm, made of diorite having the following particle size distribution in the final coated material:

| | |
|---|---|
| 6/10 | 32.7% |
| 2/6 | 15% |
| 0/2 | 24.1% |

together with reclaimed aggregates of coated materials: 24.1%

The binder is an asphalt having a penetration index of 20/30: 3.8% and a reclaiming agent is mixed-in (0.3%) (i.e. total asphalt: 5.3%)

The reclaimed aggregates of coated materials and 2/6 and 6/10 aggregates are heated to 150° C. The mixing is done with a parallel twin-shaft mixer, and the aggregates are heated with the reclaiming agent to 150°. Then, the 0/2 fraction having a water content of 4% and the asphalt (heated to 170° C.) are simultaneously added to the mixer (containing the heated fraction).

The coated material is mixed and the final temperature is 105° C.

The characteristics of the resulting coated material are shown in Table 3 below:

TABLE 3

| | | | Specifications NF | | |
|---|---|---|---|---|---|
| | | | EN 13108-1 | | |
| | | Results | C I | C II | C III |
| DURIEZ test | average void % | 7.6 | | | |
| NFP 98-251-1 | R18 (MPa) | 13.6 | | | |
| | r18 (MPa) | 11 | | | |
| | r/R | 0.81 | >0.75 | | |
| Rutting | void % | 7.1 | 5-8 | | |
| NF EN 12697- | rut at 30000 | 4 | <10 | <7.5 | <5 |
| 22 | cycles % | | | | |
| GSP | void % 60 | 8.2 | 5-10 | | |
| NF EN 12697- | gyrations | | | | |
| 32 | | | | | |
| Module | Average direct | 14156 | >5500 | >7000 | >7000 |
| according to | tension | | | | |
| NF EN 12697- | modulus | | | | |
| 26 | (15° C. - 0.02 s | | | | |
| | in MPa) | | | | |

| | | | |
|---|---|---|---|
| | average void % | 6.8 | 5-8 |
| Fatigue | ε6 at 10° C. - | 106 | >100 |
| strength | 25 Hz (μdef) | | |
| according to | average void % | 7 | 5-8 |
| NF EN 12697- | fatigue | | |
| 24 | | | |

### EXAMPLE 4

### BBSG 0/10

The solid fragments consist of aggregates having a size of 0/10 mm, having the following particle size distribution in the final coated material:

| | |
|---|---|
| 6/10 | 35% |
| 4/6 | 15% |
| 0/4 | 44.4% |

5.6% of 35/50 asphalt are mixed-in.

70% of the aggregates (20% 0/4, 15% 4/6, 35% 6/10) having an initial water content of 3% are heated in a counter-current drum dryer to a temperature of 140° C.

In a parallel twin-shaft mixer, these heated aggregates are mixed, and the following are added while mixing:

24.4% 0/4 aggregates, having an average initial water content of 4% (addition time: 8 seconds).

5.6% of asphalt at an initial temperature of 160° C. (addition time: 8 seconds).

An energy saving bituminous coated material is obtained, at a temperature of 98° C., with a manufacturing cycle time of 45 seconds (the same as for an equivalent hot-coated material). The void ratio and the module measured on cores sampled on site after 7 days conform to the NF EN 13108-1 standard.

### EXAMPLE 5

### BBSG 0/10

The solid fragments consist of 25% reclaimed aggregates of coated materials and aggregates having a size of 0/10 mm, with a particle size distribution as follows:

| | |
|---|---|
| 6/10 | 25% |
| 4/6 | 15% |
| 0/4 | 30.8% |

4.2% of 35/50 asphalt are mixed-in.

Step a1: Direct drying in a drum dryer of 10% 0/4 aggregates +15% 4/6 aggregates +25% 6/10 aggregates at a temperature of about 245° C.
Step a2: Indirect drying of 25% reclaimed aggregates of coated materials added to a recycling loop, having an average initial water content of 4%, by heat exchange with the previously heated aggregates to provide a final mixture at a temperature of 140° C.

Subsequently, the mixture obtained above is mixed in a parallel twin-shaft mixer, and the following are added while mixing:

20.8% 0/4 aggregates, having an average initial water content of 6% (addition time: 7 seconds)

4.2% pure asphalt at an initial temperature of 160° C. (addition time: 6 seconds).

An energy saving bituminous coated material is obtained, at a temperature of 98° C., with a manufacturing cycle time of 45 seconds (the same as for an equivalent hot-coated material).

The void ratio and the module measured on cores sampled on site after 7 days conform to the NF EN 13108-1 standard.

### EXAMPLE 6

### BBSG 0/10

The formula for the coated material is the same as described in Example 4.

70% of the aggregates (20% 0/4, 15% 4/6, 35% 6/10), having an initial water content of 2%, are heated in a counter-current drum dryer to a temperature of 115° C.

These heated aggregates are mixed in a parallel twin-shaft mixer, and the following are added while mixing:

24.4% 0/4 aggregates, having an average initial water content of 2.5% (addition time: 8 seconds)

5.6% additive-added asphalt (0.3 ppc Polyram® L 200) at an initial temperature of 160° C. (addition time: 8 seconds).

An energy saving bituminous coated material is obtained, at a temperature of 95° C., with a manufacturing cycle time of 45 seconds (the same as for an equivalent hot-coated material). The void ratio and the module measured on cores sampled on site after 7 days conform to the NF EN 13108-1 standard.

1. A method for manufacturing bituminous coated materials comprising solid mineral fractions coated with a binder, wherein the method comprises the sequential steps of:
a) adding to a mixer a first portion of said solid mineral fractions, said first portion having been at least partially heated beforehand up to a temperature at the inlet of said mixer which is higher than 80° C.; then
b) adding separately but simultaneously, to the same mixer, the binder and the remaining portion of said solid mineral fractions, not heated beforehand.

2. The method according to claim 1, wherein said first portion of solid fractions is itself subdivided into two portions and in that step a) is subdivided into two sequential steps of
a1) heating, at a temperature higher than 120° C., the first subdivision of said first portion of said mineral solid fractions free of reclaimed aggregates of coated materials; then
a2) mixing said first heated subdivision obtained in step a1), while hot, with the second subdivision of said first portion of the mineral solid fractions which may include reclaimed aggregates of coated materials.

3. The method according to claim 2, wherein in step a2) said second subdivision of the first portion of the solid mineral fractions comprises reclaimed aggregates of coated materials.

4. The method according to claim 1, characterized in that during step b) the whole of said remaining portion of the solid mineral fractions is mixed-in during addition of the binder.

5. The method according to claim 1, wherein during step b) the whole of the binder is mixed-in during addition of said remaining portion of the solid mineral fractions.

6. The method according to claim 1, wherein said remaining portion of said solid mineral fractions, added during step b), represent between 10 and 70% in mass, preferably between 20 and 40% in mass, of the total weight of the solid mineral fractions.

7. The method according to claim 3, wherein the reclaimed aggregates of coated materials are regenerated aggregates of coated materials.

8. The method according to claim 3, wherein the reclaimed aggregates of coated materials represent between 5 and 70% in mass of the weight of mineral solid fractions comprising said first portion.

9. The method according to claim 1, wherein a controlled amount of water is added during step b) of adding separately but simultaneously the binder and said remaining portion and/or after step b).

10. The method according to claim 1, wherein prior to step b), a controlled amount of water is added to said remaining portion of solid mineral fractions.

11. The method according to claim 1, wherein the binder is processed at a temperature in the range of between 100 and 200° C., preferably at about 160° C.

12. The method according to claim 1, wherein the binder emulsion is processed at a temperature in the range of between 10 and 95° C.
